(19) United States
(12) Patent Application Publication
(10) Pub. No.: US 2010/0139375 A1
(43) Pub. Date: Jun. 10, 2010

(54) APPARATUS AND METHOD FOR MEASURING RHEOLOGICAL PROPERTIES OF BLOOD

(76) Inventors: William R. Johns, Swansea (GB); Steven W.J. Brown, Swansea (GB); Karl Hawkins, Swansea (GB); Phylip Rhodri Williams, Swansea (GB); Philip Adrian Evans, Swansea (GB)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/527,238

(22) PCT Filed: Feb. 14, 2008
(86) PCT No.: PCT/GB08/00511

§ 371 Date: Dec. 22, 2009

(30) Foreign Application Priority Data
Feb. 15, 2007 (GB) 0703004.2

(51) Int. Cl. G01N 11/10

(52) U.S. Cl. 73/54.24

(57) ABSTRACT

An oscillating rheometer adapted for use in measuring rheological properties of blood or the propensity of blood to clot, the rheometer including at lease two surfaces between which a blood sample is introduced, said surfaces being provided as: A first surface, providing a sample receiving member defining a surface for receipt of a blood sample; A second surface, providing a sample contact surface in movable relationship to said first surface. Wherein in use, said first and second surfaces move towards each other so as to sandwich said blood sample between the first and second surfaces, with the blood sample being subjected to a controlled environment provided by way of one or more of the surfaces in contact with the blood to allow for measurement of the rheological properties of the blood or the propensity of the blood to clot.

### TECHNICAL FIELD

The present invention relates to an apparatus and method for measuring rheological properties of blood samples. In particular but not exclusively the apparatus and method may be used in assessing the propensity of a blood sample to form blood clots and further, the apparatus may also be used to assess the propensity of materials that may contact blood to stimulate clotting.

### BACKGROUND TO THE INVENTION

The propensity of (e.g. human or mammalian) blood to form clots is well-known as a defence against injury, and clotting occurs when blood leaves the blood vessels (from veins, arteries down to small capillaries) in which it is normally confined. This clotting characteristic is vitally important to ensure that humans (and other mammals) do not bleed to death whenever they suffer a cut, graze or bruise. The blood of a healthy person is finely tuned so that it does not clot in the blood vessels (or internal organs). However, when vessel integrity is lost, the blood forms clots to efficiently fill the site of injury.

The present invention focuses on three aspects of blood clotting that cause clinical concern. The first concern is the case when a clinical condition (or treatment) causes excessive clotting, so that clots form within blood vessels and migrate to areas in which they cause damage (for example the heart and lungs). The second concern is the case when a clinical condition (or treatment) reduces the ability of blood to clot, so that any minor injury can result in death through hemorrhage. The third concern is the case in which a medical device contacts the blood of a patient.

In the case of a third concern, an example of such a medical device is a mass exchange apparatus to oxygenate blood and reduce carbon dioxide concentration in the blood. The blood may recognise such a medical device as foreign and form clots on its surface, or in its vicinity. In this way, the device can put the patient's life at risk. In all three cases, it is important that the blood clotting characteristics are correctly identified so that a safe treatment can be applied and such that devices that might risk blood clotting are identified.

The present invention derives from a better understanding of the blood clotting process. Blood is a non-Newtonian fluid and its rheological properties change as clotting proceeds. For a Newtonian fluid, stress is proportional to strain rate (that is, proportional to velocity gradient). The viscosity (ratio of stress over strain rate) remains constant at all strain rates. Thus, the smallest stress causes movement of the fluid. There is no force normal to the flow direction, and no tendency for the fluid to regain its original form once the stress is removed.

For fresh healthy blood (in which clotting is not yet initiated), the smallest stress causes movement of the fluid and it has no tendency to regain its original shape after any stress or strain is removed. However, as strain rate increases, the stress increases disproportionately giving an apparently increasing viscosity.

Blood in which clotting is well established behaves like a solid at sufficiently low strain levels. Thus, the stress is proportional to the strain (not to the strain rate), and the material tends to return to its original shape once stress is removed. However, at higher stresses, the material flows. The higher the stress, the more easily the material flows. The apparent viscosity decreases with increasing strain rate.

Starting with fresh blood, clotting proceeds by links forming between platelets. Thus, the resistance to flow is noted to increase at every stress level. However, the resistance increases most at low strain rates (stresses). This progressively increasing resistance to flow increases until the time at which, for the smallest stresses, there is no flow. We identify this time with initial clot formation. The platelets have been linked such that there is a continuous path from one surface to another (or across an opening) and flow can be brought to a halt. This is also the time at which the blood changes from a fluid in which apparent viscosity increases with increasing stress to the point at which it decreases with increasing stress. Thus, the initial clotting time coincides with the time at which (in the direction of flow) blood behaves as a pseudo-Newtonian fluid.

Traditionally, the tendency for blood to clot has been characterised using a thromboelastograph (TEG machine). In use of such a TEG machine, a small blood sample is placed in an oscillating cup, which contains an element that moves against a resistance. The element contacts the blood leaving a small layer of blood between the cup and the element. The viscosity of the blood induces a force on the element. This force is of the same frequency as the cup oscillation. The strength of the force is a measure of the progress of the clotting process. For fresh blood, the force is small but, as the coagulation process proceeds, the force steadily increases. Physicians are familiar with the rate at which the force increases for healthy patients. For patients at risk of blood clots, the force is higher and increases more rapidly. For patients at risk of hemorrhage, the force is lower and increases more slowly. The force pattern for healthy blood depends on the oscillation rate and on the detailed design of the TEG machine. For higher frequencies (and amplitudes), the resistance starts higher and increases relatively slowly. For lower frequencies (and amplitudes), the resistance starts lower and increases relatively rapidly.

Conventionally, when using the TEG machine, practitioners establish a standard oscillation rate that is applied to all blood samples. They measure the time at which the stress on the element reaches a standard level that is applied to all blood samples. It will be appreciated that blood at high risk of clotting reaches this level sooner than blood with a low risk of clotting (high risk of hemorrhage). Thus, the time is compared to a “standard” time established for healthy people and significant deviation from this time is indicative of a blood-clotting problem that may need treatment.

A recent patent application, published as WO 2006/111758 improves on the TEG machine by employing an oscillating rheometer that can simultaneously apply a range of frequencies. The time at which the apparent viscosity is the same at all frequencies is the time of incipient clot formation. This time is observed to be independent of the detailed design of the rheometer, and independent of the frequency pattern applied. Thus, there is no need to define an arbitrary oscillation frequency, or an arbitrary stress level. Furthermore, the time at which the coincidence of stress occurs corresponds to a physically significant event (initial clot formation). Multiple frequencies are applied by moving the plate according to the sum of a number of sinusoidal disturbances. The frequencies of the sinusoidal waves are multiples of a basic frequency. Hence, the resultant complex pattern of movement is repeated at the basic frequency. The resultant stress pattern has the same basic frequency. However, it differs in shape from the applied pattern. This pattern in the time domain is deconvoluted to the frequency domain by applying a Fourier Transform. In this way, a stress pattern is reconstructed such that for each applied sine wave, a corresponding sine wave of different frequency is obtained. Thus, stress/strain relationships are derived for a range of frequencies applied simultaneously. For high frequency sine waves, the stress increases relatively slowly with time. For low frequency sine waves, it increases more rapidly. The time at which the stress/strain relationship is the same for all frequencies is easily observed.

The present invention derives from Applicant's observation that the readings from both TEG machines and rheometers (e.g. oscillating rheometers) depend on the materials of the apparatus with which the blood is in contact during the assessment procedure. The readings may also depend on any surface treatment applied to the materials. Thus, the measured clotting time of blood is not a property intrinsic to a particular blood sample. It is a property that depends on the interaction between blood and the materials of the apparatus with which it is in contact. For some materials, blood clots continually break away from the surface, which greatly reduces the measured stresses. However, these blood clots can still be detected by a multiple-frequency oscillating disc rheometer.

Building on this observation, the present invention seeks to overcome problems associated with the prior art by providing an improved method for measuring the rheological properties of blood samples, and thereby assessing the propensity of a blood sample to form blood clots.

Secondly, the present invention has the improvement of providing a rapid and reliable way of assessing the propensity of particular materials of the apparatus to give rise to blood clotting. Thus, there is provided a method for assessing candidate materials for use in the construction of blood-contacting medical devices.

Further, the Applicant has also noted that the measured clotting propensity is to be applied to flows through blood vessels and through medical devices. When blood flows through such elements, there is a radial stratification of the blood flow. For example, the concentration of platelets at the axis is greater than at the outer wall of the blood vessel (or medical device). Thus, the blood clotting characteristics determined by an oscillating rheometer may not reflect the characteristics to be found in practice. Therefore thirdly, the Applicant has devised a novel flow rheometer to capture the clotting characteristics in continuous flow through conduits (for example, blood vessels).

By way of further background, it is noted that conventionally two main steps are taken to assess the suitability of candidate materials for use in devices that contact blood. The first step is to observe blood that has been in contact with the candidate materials in controlled tests. The blood is analysed to detect components of the candidate materials that promote blood clotting, for example, fibrin. The second step is to undertake long-term animal tests of the candidate materials. The advantage provided by the present invention is that in one use aspect, relevant (e.g. thrombogenic) properties of the candidate materials may be tested rapidly using small samples of human blood. Furthermore, in another use aspect, the present invention may enable tests of biocompatability to be undertaken with the blood of the actual patient who is proposed to receive the proposed blood-contacting medical device. This utility may be particular important for patients who suffer from conditions that adversely influence the blood clotting characteristics of those patients.

The Applicant has also appreciated that blood clotting characteristics may depend on characteristics such as blood gas composition (for example, the level of oxygenation) but other features such as levels or type of medication given to an individual, genetic factors and even the state of health may alter the characteristics. It is known that the clotting mechanism differs to some extent in arterial (oxygenated) blood and in venous (deoxygenated) blood. Thus, anticoagulants favoured for venous blood include heparin and warfarin. Anticoagulants favoured for arterial blood include aspirin. Furthermore, the acidity (pH) of blood depends on blood gas composition. Blood/surface interaction can depend on pH, so that without control of blood gas composition, measures of propensity of blood to clot may be spurious. Currently, no device for characterising blood clotting characteristics makes provision for controlling blood gas composition. The present invention includes a facility to control blood gas composition. For a flow rheometer, blood gas composition can be controlled by a mass exchanger (as described in the prior patent W02005/118025, to Haemair Ltd, inventor W R Johns), which can be upstream of the rheometer or integral with the rheometer as a combined rheometer and mass exchanger. For an oscillating rheometer, blood gas composition can be controlled using a modified rheometer incorporating a controlled atmosphere, or by a modified rheometer in which one of the plates is replaced by a gas permeable membrane. The rheometer then becomes a combined rheometer and mass exchanger.

### SUMMARY OF THE INVENTION

According to a first aspect of the present invention there is provided an oscillating rheometer adapted for use in measuring rheological properties of blood or the propensity of blood to clot, the rheometer including at least two surfaces between which a blood sample is introduced, said surfaces being provided as

a first surface, providing a sample receiving member defining a surface for receipt of a blood sample;

a second surface, providing a sample contact surface in movable relationship to said first surface

wherein in use, said first and second surfaces move towards each other so as to sandwich said blood sample between the first and second surfaces, with the blood sample being subjected to a controlled environment provided by way of one or more of the surfaces in contact with the blood to allow for measurement of the rheological properties of the blood or the propensity of the blood to clot.

According to a second aspect of the present invention there is provided an oscillating rheometer adapted for use in measuring rheological properties of blood or the propensity of blood to clot, the rheometer including at least two surfaces between which a blood sample is introduced, said surfaces being provided as

a first surface, providing a sample receiving member defining a surface for receipt of a blood sample;

a second surface, providing a sample contact surface in movable relationship to said first surface

there being in flush contact with at least one of the first or second surfaces a test material

wherein in use, said first and second surfaces move towards each other so as to sandwich said blood sample between the test material and the sample contact surface that comes into contact with the blood sample for measurement of the rheological properties of the blood or the propensity of the blood to clot.

According to a third aspect of the present invention there is provided an oscillating rheometer adapted for use in measuring rheological properties of blood or the propensity of blood to clot, the rheometer including at least two surfaces between which a blood sample is introduced, said surfaces being provided as

a first surface, providing a sample receiving member defining a surface for receipt of a blood sample;

a second surface, providing a sample contact surface in movable relationship to said first surface

with at least one of the first or second surfaces being formed of a test material

wherein in use, said first and second surfaces move towards each other so as to sandwich said blood sample between a surface formed of the test material and a sample contact surface for measurement of the rheological properties of the blood or the propensity of the blood to clot.

Preferably, the controlled environment is provided by the surfaces that contact the blood and these can be the plates of the rheometer or test materials, which may be provided as membranes, which are associated with the surfaces or plates. It is even envisaged that the surfaces may be formed of the test material itself. The test material is envisaged as being a material that is being observed in relation to how blood reacts and clots when in the presence of the material and/or the effect of the material on blood and its clotting characteristic.

It is envisaged that the rheometer is selected from known types of rheometers, such as disc rheometers, or cup and pin rheometers.

Further, although surfaces are mentioned, the surfaces may be plates, discs, cups or other irregular surfaces. For the sake of brevity, we have referred from now on the surfaces as being sample plates.

In a preferred arrangement, the sample plate is a base plate for receiving the blood sample. However, the sample plate may be a plate which is positioned above the base plate and which can receive blood in a blood holding structure.

The sample plate defines a surface for receipt of a blood sample. The blood sample typically comprises a drop or aliquot of blood, for example of volume 1 ml to 20 ml depending on the level of blood that needs to be tested. It is envisaged however that that amount used would be approximately 1.1 ml up to 5 ml in most situations.

In a preferred arrangement, this sample plate is made of a test material, or a material designed to have surface properties that mimic the inside of a blood vessel. The test material may have a surface treatment designed to provide desired properties.

Alternatively, the sample plate may have intimately attached to it a membrane of the desired properties. In order to control blood gas composition, the sample plate may be porous and covered with a gas-permeable membrane. The underside of the plate then has a gas flow of desired composition so that mass transfer through the membrane maintains desired blood gas equilibrium partial pressures.

The blood blood gas composition can be controlled by a mass exchanger, (as described in the prior patent W02005/118025, to Haemair Ltd, inventor W R Johns), which can be upstream of the rheometer or integral with the rheometer as a combined rheometer and mass exchanger.

It is envisaged that the sample contact surface, which may be in the form of a plate forming an upper plate, is made of the same material, with the same surface coating, as the lower surface or plate, or has the same membrane material and coating as the lower plate. The upper surface or plate is impervious to gas and diffusion.

In an alternative design, the upper surface or plate may support gas diffusion instead of the lower surface or plate.

Preferably, when the blood sample is held between said first and second plates, the blood sample is sealed around its circumference by a fluid that is impervious to gas diffusion.

It is envisaged that one or both plates are replaceable. By having such an arrangement, a standard oscillating rheometer, such as a disc rheometer can be used.

It is also preferred that the apparatus of the invention includes the option to control blood gas composition.

The sample plate is generally mounted in fixed relationship to the body of the rheometer, which in turn is generally arranged to sit on a laboratory bench in static relationship thereto.

The sample plate generally comprises a metal (e.g. steel or titanium) plate. The base surface is preferably flat. The base surface is preferably smooth. However, where the plate also serves to control blood gas composition, it is desirable that the material is porous. Such a porous (or microporous) base plate can optionally be covered with a gas permeable test material such as a membrane

It is preferred that the sample plate is disc-shaped such that a circular base surface is defined. Disc diameters for the base plate of from 50 to 150 mm are most preferred.

It is desirable to control the temperature of the sample plate. Therefore, according to a further feature of the invention, the sample plate is provided with a temperature controller. The temperature controller may comprise heating and/or cooling means and a thermometer. Suitable electronic circuitry is provided to enable effective temperature control.

There is also provided in movable relationship to the base plate, a sample contact plate. This is generally an upper plate. The sample contact plate upper plate is generally mounted to a movable head, which is mounted for movement with respect to the body of the rheometer.

In preferred embodiments, the first and second plates are in parallel relationship with respect to each other. It is envisaged that the sample contact plate (often an upper plate) is movable towards and away from (e.g. up and down) the sample plate (usually a base plate) whilst still maintaining this parallel relationship.

The sample contact plate generally comprises rigid material, which in embodiments may be a metal (e.g. steel, aluminum or titanium) or a plastic polymeric material (e.g. Perspex). In embodiments, the base plate is disc-shaped such that a circular upper plate surface is defined. The sample contact plate surface is preferably flat. The upper plate surface is preferably smooth. Disc diameters for the upper plate of from 50 to 150 mm (e.g. 60 mm) are most preferred.

In embodiments, the sample contact plate (as for the sample plate itself) is releasably connectable from the (e.g. movable head of) the rheometer. Thus, in use aspects, upper plates of different sizes and materials may be employed.

In preferred embodiments, both the upper and the lower plates are replaceable with plates made of desired test, or biomimetic, materials and surface treatments.

In alternatives, the plates are not replaceable, but can be further provided with, in flush contact with the upper plate, a membrane layer defining a membrane surface. The membrane surface is preferably flat. The membrane surface is preferably smooth. In embodiments, the membrane layer is disc-shaped such that a circular membrane surface is defined. Disc diameters for the membrane layer of from 50 to 150 mm are most preferred.

The membrane layer can be of any thickness but a typical thickness is 2 to 10 microns.

In use, the base plate and upper plate move towards each other such as to sandwich the blood sample between the base surface and the membrane surface for measurement of the rheological properties of that blood sample.

In use, the distance between the surfaces of the upper and lower plates base is from 100 to 400 microns. Where membranes are attached to the plates, the distance between the blood-contacting surfaces of the membranes is from 100 to 400 microns.

Where test materials are employed (which will also be referred to as membrane) each membrane layer is in flush contact with its appropriate plate (upper and lower plate respectively) and in preferred embodiments is in fixed relationship with its appropriate plate. All suitable means of reversibly, or irreversibly, fixing the membrane layer to the base plate is envisaged including mechanical and adhesive fixing.

In embodiments, the membrane layer is provided to a frame and in turn that frame is adapted for mechanical fixing (e.g. clip-on or screw-on) to the upper plate. Suitably, the plates are disc-shaped and the frame is ring-shaped and sized for ready and reversible fixing to the disc-shaped upper plate.

In embodiments, the framed membrane layer and/or the membrane layer with adhesive layer are arranged to be disposable.

Alternatively, the membrane may be provided with an adhesive so that the membrane can be releasably attached to a selected surface or plate.

In other embodiments, the surfaces of the for example, upper and lower plates are of different materials or different surface treatments. For example, it may be desired to provide a standard surface finish on one plate and a test material or surface on the other plate. These surfaces may optionally be provided by membranes that are fixed to one surface, or to both surfaces.

All of the above features can be used in a method for measuring rheological properties of blood sample.

Thus, there is also provided in accord with a further aspect of the present invention a method of testing the rheological properties of a blood sample or the propensity of a blood sample to clot, whereby

a blood sample is introduced onto a sample surface of an oscillating rheometer, said sample surface having a test material attached thereto

a sample contact surface is brought into contact with the blood sample to sandwich said blood sample between said test material and said sample contact plate, and the rheological properties or propensity of the blood to clot is measured.

In a preferred arrangement, the sample contact surface also has a test material on its surface.

In a further arrangement, one or both the sample surface and the sample contact surface may be formed of the test material.

The oscillating rheometer, which can be for example a disc rheometer or a cup and pin rheometer is used to determine the propensity of the blood sample to clot by reference to the rheological properties thereof and in particular, the oscillating disc rheometer is employed to determine propensity of the material of the membrane layer to give rise to clotting of the blood sample, by reference to the rheological properties of that blood sample when in the presence of that membrane material. Thus, the suitability of that membrane material for use as a component of a blood-contacting device (e.g. for use inside the patient) may be assessed.

The apparatus and method described herein is suitable for use with a human or animal (particularly mammalian) blood sample.

It is envisaged that the blood sample can be maintained in a controlled environment for observation of clotting characteristics, either by controlling and selecting the test material to be used or by altering the flow of materials such as gases across the test material, which may be provided as a membrane.

There are three purposes to this interchange:

1) The instrument becomes a tool for testing the thrombogenic properties of materials. Thus, we have a new, fast, and simple way of testing whether materials promote blood clotting, or suppress blood clotting. This tool is much quicker and cheaper than animal testing. It uses blood from volunteer people. It also achieves excellent testing without the ethical problems of animal testing. It uses extremely small samples of blood so that tests can be repeated a sufficient number of times to be statistically significant.

2) The suitability of implant material can be tested with the blood of the actual people for whom implanted medical devices are being considered. It provides an indicator of the safety of the implant to be assessed.

3) Current blood coagulation testing (using TEG machines) is specific to the materials of construction used in these machines. Thus, it does not test the clotting risk under the conditions likely to be met in the patient. In this respect, it must be a poor guide as to whether anticoagulants (such as heparin or warfarin) should be administered. Nor does it give an indication of the dose required. By using materials that may mimic the conditions within the circulation, we can obtain a better estimate of the real clotting risk that the patients are exposed to. Such biomimetic candidate materials include phosphorylcholine-based surfaces but it is envisaged that it is possible to use surfaces that actually include living epithelial cells.

We believe that some such surfaces can, with particular blood, give rise to clots that rapidly break away. The TEG machine may then fail to detect the clots at all. The oscillating rheometer (and we believe, the tubular sequential device that we describe) gives a better indication and has been shown to detect clots for surfaces for which the clots do break away. We propose that routine blood coagulation testing should be undertaken using rheometers with materials whose behaviour more closely mimics the behaviour of surfaces found in living mammals. Only in this way, can reliable indications be produced for optimal patient care.

In an alternative embodiment of the device, we define a novel flow rheometer

The rheometer consists of a series of channels (for example, tubes) of decreasing cross-sectional area. A pseudo-viscosity can be computed for each length of tube. The velocity and velocity gradient increase from tube to tube. For blood that has not reached its gel point (point of incipient coagulation), the pseudo-viscosity increases as the velocity gradient increases. For blood that is past its gel point, the pseudo-viscosity decreases as the velocity gradient increases. Thus, by recycling a small volume of blood through the flow rheometer, the progress of coagulation can be tracked. Alternatively, the parameters in the constitutive equations can be fitted from the pressure profiles. In either case, the gel-point can be predicted or forecast. Where no clots adhere to surfaces, the rate at which the parameters change gives a measure of the propensity for blood to clot. The tubes can conveniently be placed in a thermostatically controlled outer tube (or conduit) to control the blood temperature. As for the oscillating rheometer, the apparatus can be used either to characterise the clotting propensity of the blood or the tendency of materials contacting blood to stimulate clotting. The tubes themselves can be interchangeable to test alternative materials, or the tubes can be made of materials chosen to be non-thrombogenic. In the latter case, the test material, or test device, can be placed upstream of the rheometer in order to monitor its propensity to stimulate blood clotting.

Preferably, the tubes (or conduits) should have a diameter (or cross-sectional dimension) of a fraction of a millimetre. In this way, it mimics the dimensions employed in some medical devices (for example, a mass exchanger) and the sizes of small blood vessels in which clots may be a hazard. The volume is also sufficiently small to employ blood samples as small as, or smaller than, those employed in the oscillating rheometer.

### BRIEF DESCRIPTION OF THE DRAWINGS

The present invention will now be described by way of example only with reference to and as illustrated in the accompanying figures in which

FIG. 1 shows a perspective view from the front of a standard oscillating rheometer (which in this case is a disc rheometer)

FIG. 2 shows a perspective, part cut-away view from the side of the standard oscillating disc rheometer of FIG. 2, but with the base plate removed;

FIG. 3 shows a cross-sectional view of the blood sample-receiving part of a first oscillating disc rheometer in accord with the present invention;

FIG. 4 shows a cross-sectional view of the blood sample-receiving part of a second oscillating disc rheometer in accord with the present invention;

FIG. 5 shows a perspective view of a membrane layer defined within a frame and arranged for reversible fixing to an upper plate of an oscillating disc rheometer in accord with the present invention;

FIG. 6 shows a perspective view of a membrane layer provided with an adhesive layer and arranged for reversible adhesive fixing to an upper plate of an oscillating disc rheometer in accord with the present invention;

FIG. 7a shows an alternative embodiment where compositions in the blood sample are controlled by using a porous plate with a gas permeable membrane;

FIG. 7b shows a section through the blood sample shown in FIG. 7a; and

FIG. 8 shows an example of a way applying strain rates sequentially to a sample using a sequence of tubes of decreasing diameter.

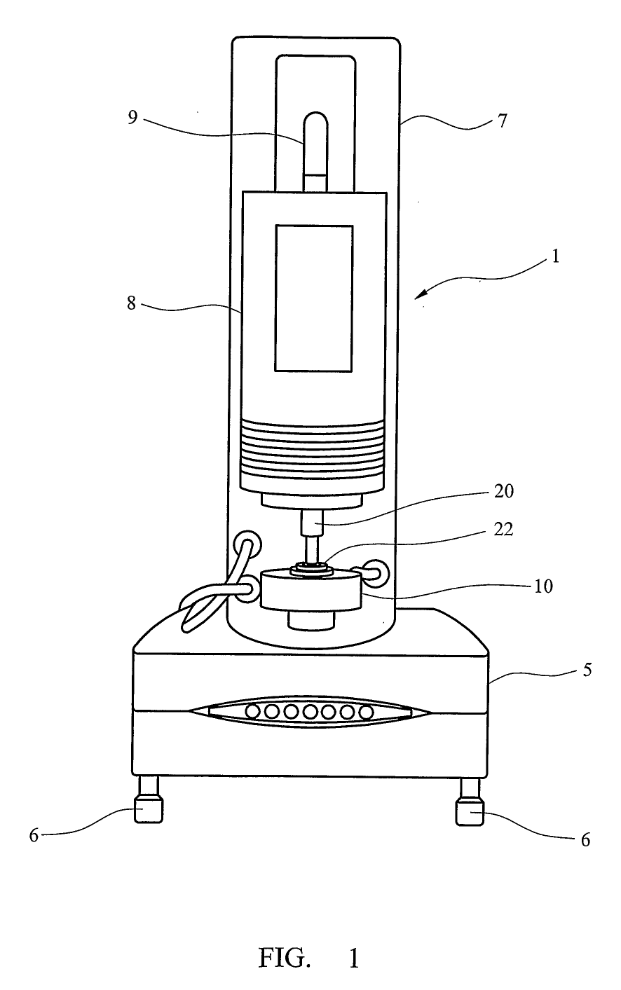

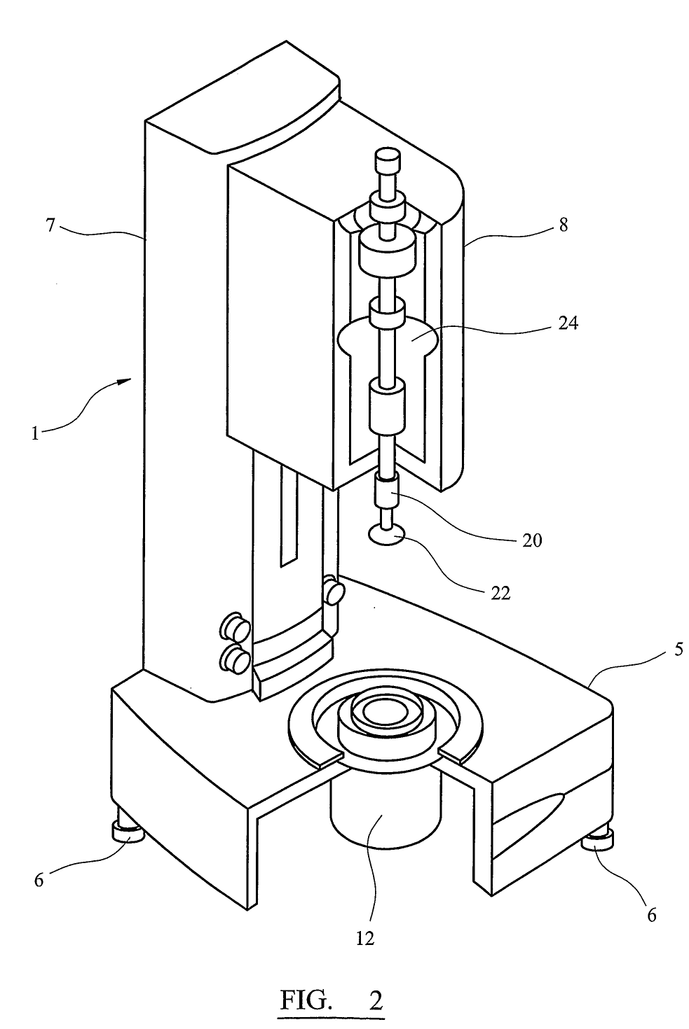

Turning now to the drawings, FIGS. 1 and 2 show a standard oscillating disc rheometer 1 prior to its adaptation in accord with the present invention. One example of such is the AR-G2 Rheometer as sold by TA Instruments, which is a controlled stress rheometer that is capable of applying multiple frequency oscillations at torque levels of less than 1 micro Nm, which makes it ideally suited for viscoelastic characterisation of strain sensitive materials such as blood.

The rheometer 1 comprises a body defining a lower body 5, which is provided with feet 6 for standing on a laboratory bench or other flat surface, and standing proud therefrom an upper body 7, to which is provided a movable housing unit 8. The movable housing unit 8 is arranged for reversible up and down movement along a track 9 relative to the upper body 7.

The lower body 5 is provided with a circular steel base plate 10, which is in fixed relationship to a normal force transducer 12 that is itself fixed to the lower body 5. The temperature of the base plate 10 is controlled via a Peltier system. The movable housing unit 8 of the upper body 7 is provided with a spindle 20 that at its lower end is provided with a detachable circular, disc-shaped upper plate 22. It will be appreciated that the base plate 10 and upper plate 22 are in parallel relationship with each other. The movable housing unit 8 contains a magnetic bearing and motor 24, which allows precision control of applied stress, and an optical encoder device (not visible) for measurement of angular displacement.

In use, an aliquot of blood (i.e. the blood sample to be assessed) is transferred to the base plate 10 and the upper parallel plate 22 is lowered to a pre-set gap (typically, 100 to 400 microns), where upon it comes in contact with the blood sample such that the sample is sandwiched between the plates 10, 22. The upper plate 22 is free to subject controlled stress oscillations on the blood sample. The rheometer 1 applies a complex stress waveform consisting of several frequencies simultaneously and measures the resulting displacement/strain waveform. Using a suitable Fourier analysis, the software of the rheometer calculates the viscoelastic parameters G′ G″ and phase angle at each individual frequency. This multi-frequency procedure, known as Fourier Transform Mechanical Spectroscopy (FTMS), is an ideal tool for detecting the gel point in transient systems, and consequently, by applying appropriate fractal analysis, it yields a measure of the structure of the gel network in terms of a fractal dimension. Rheological properties of the blood sample may thus, be analysed.

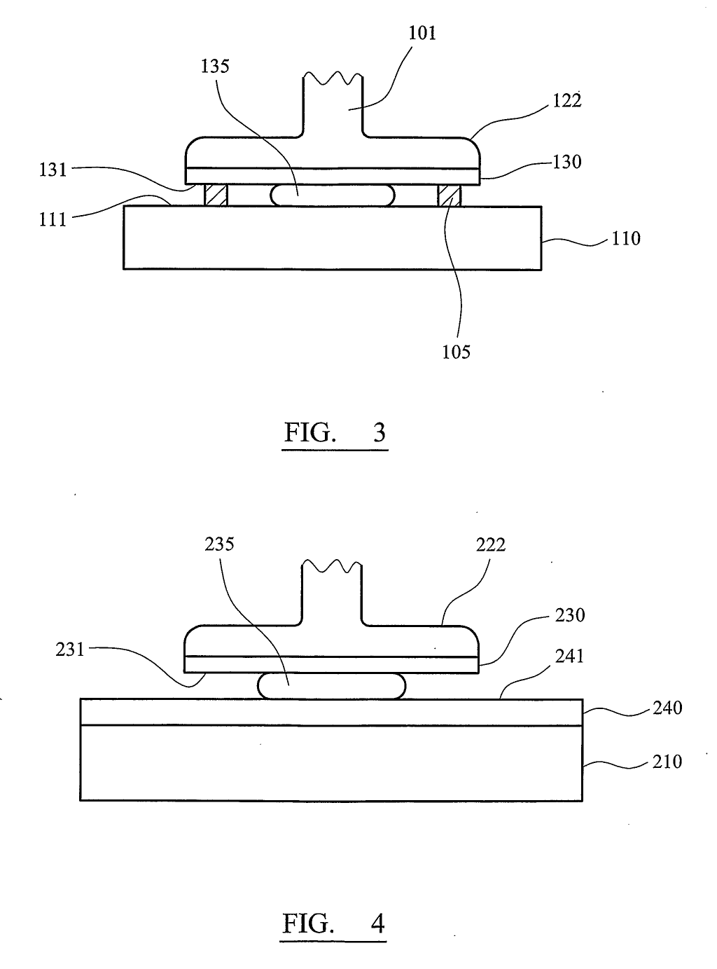

FIGS. 3 and 4 show, in use, configurations of the blood sample-receiving part of a standard oscillating disc rheometer (e.g. as shown in FIGS. 1 and 2) that has been adapted in accord with first and second embodiments of the present invention. FIG. 3 shows the upper and lower plates of an oscillating disc rheometer with a blood sample between the discs and an inert oil around the circumference of the blood. FIG. 3 shows an axial section of the relevant parts. The shaft (101) drives the upper disc (122). The lower disc is 110. The blood sample is 104. This sample is surrounded by an inert fluid, 105 (for example, silicone oil) to minimize mass transfer to and from the blood. The inert fluid is an optional feature and may be omitted.

As an alternative to the use of an inert liquid around the blood sample, the rheometer plates can be in a sealed volume with a controlled atmosphere. This atmosphere would typically have an oxygen partial pressure of from 5 to 15 kPa and a carbon dioxide partial pressure from 3 to 10 kPa.

The invention covers alternative means of fixing membranes to one or both plates. It also covers alternative designs of rheometer in which, for example, the bottom plate may be driven.

Thus, FIG. 3 shows circular steel base plate 110, which defines a base surface 111 for receipt of blood sample 135. In parallel relationship with the base plate 110, there is circular titanium upper plate 122, to which a membrane layer 130 has been provided in flush contact with therewith. The membrane layer 130 defines a membrane surface 131. FIG. 3 shows an in use configuration in which, the base plate 110 and upper plate 122 have been moved towards each other such as to sandwich the blood sample 135 between the base surface 111 and the membrane surface 131 for measurement of rheological properties of the blood sample. The gap between the base surface 111 and the membrane surface 131 in this in use configuration is from 100 to 400 microns.

FIG. 4 shows a cross-sectional view of the blood sample-receiving part of a second oscillating disc rheometer in accord with the present invention;

FIG. 4 also shows circular steel base plate 210, to which a first membrane layer 140 defining a base membrane surface 241 has been provided, wherein base membrane surface 241 is arranged for receipt of blood sample 235. In parallel relationship with the base plate 210, there is circular titanium upper plate 222, to which a second membrane layer 230 has been provided in flush contact with therewith. The second membrane layer 230 defines an upper membrane surface 231. FIG. 4 shows an in use configuration in which, the base plate 210 and upper plate 222 have been moved towards each other such as to sandwich the blood sample 235 between the base membrane surface 241 and the upper membrane surface 231 for measurement of rheological properties of the blood sample. The gap between the base membrane surface 241 and the upper membrane surface 231 in this in use configuration is from 100 to 400 microns.

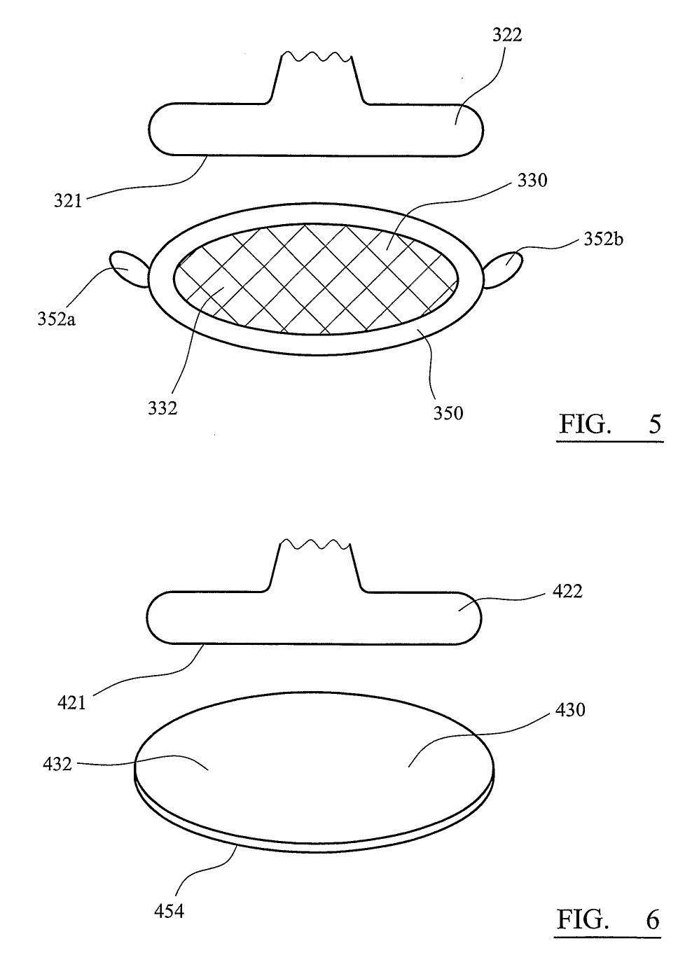

FIG. 5 shows a circular membrane layer 330 defined within a ring-shaped frame 350. The ring-shaped frame is provided with clip-on fixings 352a, 352a arranged for reversible clip-on fixing to the periphery of upper plate 322, which has the same general form as that upper plate of the rheometer of FIGS. 1 and 2. When so-fixed, the upper membrane surface 332 should be in flush contact with the flat surface 321 of the upper plate 322 and the membrane 330 itself should be flat. In alternatives screw-on fixing is employed instead of clip-on fixing 352a, 352b.

FIG. 6 shows a circular membrane layer 430 provided at its underside with an adhesive layer 454 arranged for reversible adhesive fixing to the flat surface 421 of upper plate 422, which again has the same general form as that upper plate of the rheometer of FIGS. 1 and 2. When so-adhesively fixed, the upper membrane surface 432 should be in flush contact with the flat surface 421 of the upper plate 422 and the membrane 430 should itself be flat.

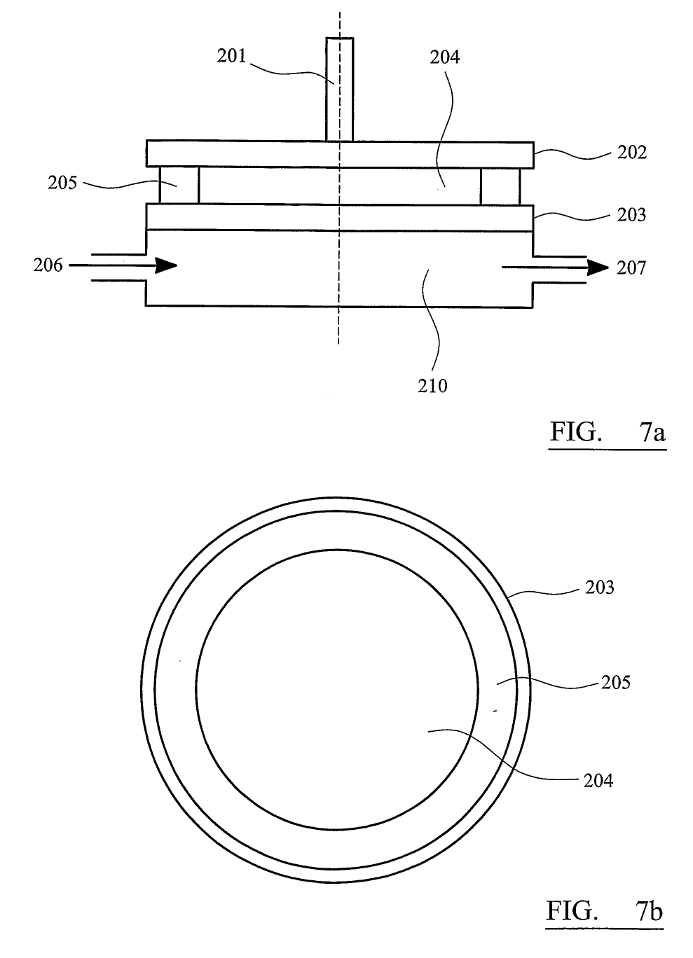

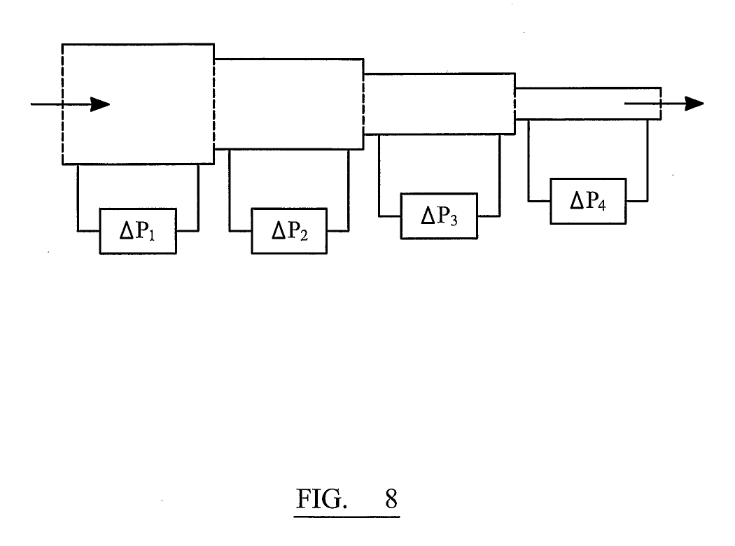

FIG. 7a shows an alternative design in which gas compositions in the blood sample are controlled by employing a porous surface which in this case is shown as a plate with a gas-permeable membrane. FIG. 7a shows an axial section of the relevant parts. The shaft (201) drives the upper disc (202). The lower disc is 203. This disc is porous and includes, on its upper surface, a gas-permeable membrane. Below the disc is a volume (210) in which there is gas of controlled composition. The gas flows into the vessel at inlet 206 and exits at outlet 207. The gas temperature is controlled externally in order also to control the temperature of the blood sample. The blood sample is 204. This sample is surrounded by an inert fluid, 205 (for example, silicone oil) to minimize mass transfer to and from the blood. FIG. 7b shows a horizontal section through the blood sample. In the option illustrated, the discs are interchangeable in order to evaluate the effects of alternative blood-contacting materials. An alternative option is for the discs to be fixed but for exchangeable surfaces to be fixed to one or both discs. A further alternative is for exchangeable surfaces to be fixed to interchangeable discs.

In embodiments, the present invention exhibits at least two of the following features:
1) The ability to measure stress in blood subject to a range of strain rates.
2) The ability to replace all surfaces that contact blood with alternative surfaces.
3) The ability to employ surfaces that mimic the inner surface of blood vessels. It is recognised that a complete match with such a surface may be impossible. However, surfaces that more nearly mimic biological surfaces than current devices provide a better measure of how blood may clot in a patient.
4) The ability to control blood gas concentrations.

The multiple strain rates may be applied simultaneously or sequentially.

As an example of applying strain rates simultaneously, consider an oscillating disc rheometer. The rheometer is operated with a convoluted oscillation composed of multiple superimposed sine waves. The resulting stress pattern is deconvoluted (for example, using a Fourier transform). The stress/strain rate relationship for each oscillation rate can then be computed and the progress of blood coagulation followed.

As an example of applying strain rates sequentially, consider an apparatus consisting of a sequence of tubes of decreasing diameter as shown in FIG. 8. These tubes can be very fine (fractions of a millimetre). In this way, a total blood inventory of a fraction of a millilitre is sufficient to fill the apparatus. A suitable apparatus is illustrated in FIG. 8. The blood is passed into the tube of largest diameter. The pressure difference along the length of each tube is measured in order to compute an apparent viscosity. In FIG. 8, the tube diameters decrease sequentially. Thus, the blood velocity increases in each successive section and the velocity gradients (strain rates) consequently increase. For each section, an apparent viscosity can be computed from the pressure drop measurements, diameters and flow rates. If the apparent viscosity increases from section to section, the blood is below incipient the clotting point. If the apparent viscosity decreases from section to section, the blood coagulation has proceeded beyond the initial clotting point. Entry/exit effects can be minimized by arranging for tapered connections between the tubes, instead of the stepped changes illustrated. As an alternative, a single tapered tube could be employed. The calculation of apparent viscosity then requires a more complex (but known) formula. The effect of time on blood coagulation can be computed by recycling the blood through the apparatus.

Both the simultaneous and the sequential rheometry devices can be designed to have replaceable materials in contact with the blood. An improved oscillating plate rheometer can be achieved by ensuring that the contact discs are easily replaceable. The sequential flow rheometer can be designed such that all materials in contact with the blood can be replaced. For example, the pressure profile tube can be replaced together with all tubing and any blood reservoirs. The recycle is most easily achieved using a peristaltic pump so that only the tubing needs to be replaced in order to put a different material in contact with the blood.

For routine blood-coagulation tests, the TEG apparatus can be replaced by an apparatus that has blood contact surfaces that are non-thrombogenic. In this way, we obtain clotting characteristics that are more nearly functions of blood properties alone, rather than functions of the interaction between and arbitrarily selected material of construction and a specific blood sample.

Blood gas concentrations can be controlled by passing the recycled stream through a mass exchanger. This exchanger can have a small area if its only purpose is to maintain the blood gas concentrations at a preset level. In all cases, accurate temperature control is required because blood-gas equilibrium concentrations are temperature dependent, as is blood rheology.

It should be emphasized that the examples illustrated are indicative. Alternative simultaneous designs would include tubes in parallel. There are alternative designs in which flow is through non-circular channels. For example, it could be between two flat sheets that are closely spaced at accurately controlled separations. It may be easier to manufacture and interchange small flat sheets than small diameter tubes. There are also many foreseeable variants to the oscillating rheometer design. The lower disc could be replaced by a shallow flat-bottomed container in order to minimize the use of fluids to eliminate direct blood/air contact. Similarly, this lower disc could be gas-permeable in order to control blood gas levels accurately. The levels of gas passing through the membrane may be controlled and for example the ratios of gases such as the level of carbon dioxide, nitrogen and or oxygen. By using this controlled environment the rheological and blood clotting characteristics of the blood can be observed both easily and accurately.

It will be understood that the present disclosure is for the purpose of illustration only and the invention extends to modifications, variations and improvements thereto.

Further the invention is intended to not only cover individual embodiments described but also combinations of the features and embodiments described.

The application of which this description and claims form part may be used as a basis for priority in respect of any subsequent application. The claims of such subsequent application may be directed to any feature or combination of features described therein. They may take the form of product, method or use claims and may include, by way of example and without limitation.

1-14. (canceled)

15. An oscillating rheometer adapted for use in measuring rheological properties of blood or the propensity of blood to clot, the rheometer including at least two surfaces between which a blood sample is introduced, said surfaces being provided as:
a first surface providing a sample receiving member defining a surface for receipt of a blood sample;
a second surface providing a sample contact surface in movable relationship to said first surface.
wherein in use, said first and second surfaces, move towards each other so as to sandwich said blood sample between the first and second surfaces, with the blood sample being subjected to a controlled environment provided by way of one or more of the surfaces in contact with the blood, to allow for measurement of the rheological properties of the blood or the propensity of the blood to clot.

16. A rheometer according to claim 15, wherein at least one of said first and second surfaces is formed of a test material or is in flush contact with a test material.

17. A rheometer according to claim 15, wherein when the blood sample is sandwiched between said first and second surfaces, the blood sample is sealed around its circumference by a fluid that is impervious to gas diffusion.

18. A rheometer according to claim 15, wherein one or both surfaces are replaceable.

19. A rheometer according to claim 15, wherein one of said first and second surfaces is provided with a temperature controller comprising heating and/or cooling means and a thermometer.

20. A rheometer according to claim 15, wherein the first and second surfaces are in substantially parallel relationship with respect to each other.

21. A rheometer according to claim 20, wherein one of said first and second surfaces is movable away or towards said other surface whilst still maintaining this parallel relationship.

22. A rheometer according to claim 15, wherein, in use, the distance between the first and second surfaces is from 100 to 400 microns.

23. A rheometer according to claim 15, comprising a series of channels of decreasing cross-sectional area.

24. An oscillating rheometer adapted for use in measuring rheological properties of blood or the propensity of blood to clot, the rheometer including at least two surfaces between which a blood sample is introduced, said surfaces being provided as:
a first surface, providing a sample receiving member defining a surface for receipt of a blood sample;
a second surface, providing a sample contact surface in movable relationship to said first surface;
there being a test material in flush contact with at least one of the first or second surfaces,
wherein in use, said first and second surfaces, move towards each other so as to sandwich said blood sample between the test material and the sample contact surface, that comes into contact with the blood sample for measurement of the rheological properties of the blood or the propensity of the blood to clot.

25. A rheometer according to claim 24, wherein said test material is in the form of a membrane attached to at least one of said first and second surfaces.

26. A rheometer according to claim 25, wherein said at least one of said first and second surfaces is porous and said membrane is gas-permeable.

27. A rheometer according to claim 24, wherein when the blood sample is sandwiched between said first and second surfaces the blood sample is sealed around its circumference by a fluid that is impervious to gas diffusion.

28. A rheometer according to claim 24, wherein one of said first and second surfaces is provided with a temperature controller, comprising heating and/or cooling means and a thermometer.

29. A rheometer according to claim 24, wherein the first and second surfaces are in substantially parallel relationship with respect to each other.

30. A rheometer according to claim 29, wherein one of said first and second surfaces is movable away from or towards the other surface whilst still maintaining this parallel relationship.

31. A rheometer according to claim 24, wherein, in use, the distance between the first and second surfaces is from 100 to 400 microns.

32. A rheometer according to claim 24, comprising a series of channels of decreasing cross-sectional area.

33. An oscillating rheometer adapted for use in measuring rheological properties of blood or the propensity of blood to clot, the rheometer including at least two surfaces between which a blood sample is introduced, said surfaces being provided as:
a first surface, providing a sample receiving member defining a surface for receipt of a blood sample;
a second surface, providing a sample contact surface in movable relationship to said first surface;
with at least one of the first or second surfaces being formed of a test material,
wherein in use, said first and second surfaces, move towards each other so as to sandwich said blood sample between a surface, formed of the test material and a sample contact surface for measurement of the rheological properties of the blood or the propensity of the blood to clot.

34. A rheometer according to claim 33, wherein when the blood sample is sandwiched between said first and second surfaces the blood sample is sealed around its circumference by a fluid that is impervious to gas diffusion.

35. A rheometer according to claim 33, wherein one of said first and second surfaces is provided with a temperature controller, comprising heating and/or cooling means and a thermometer.

36. A rheometer according to claim 33, wherein the first and second surfaces are in substantially parallel relationship with respect to each other.

37. A rheometer according to claim 36, wherein one of said first and second surfaces is movable away from or towards the other surface whilst still maintaining this parallel relationship.

38. A rheometer according to claim 33, wherein, in use, the distance between the first and second surfaces is from 100 to 400 microns.

39. A rheometer according to claim 33, comprising a series of channels of decreasing cross-sectional area
